(19) United States
(12) Patent Application Publication
(10) Pub. No.: US 2009/0075190 A1
(43) Pub. Date: Mar. 19, 2009

(54) Imaging member having a dual charge generation layer

(75) Inventors: Liang-Bih Lin, Rochester, NY (US); Daniel V. Levy, Philadelphia, PA (US); Markus Silvestri, Fairport, NY (US)

Correspondence Address: PILLSBURY WINTHROP SHAW PITTMAN, LLP;XEROX CORPORATION, P.O. BOX 10500, MCLEAN, VA, 22102, US

(73) Assignee: XEROX CORPORATION, Stamford, CT (US)

(21) Appl. No.: 11/901,110

(22) Filed: Sep. 14, 2007

(51) Int. Cl. G03G 15/02

(52) U.S. Cl. 430/57.2; 399/286

(57) ABSTRACT

The presently disclosed embodiments are directed to charge transport layers useful in electrostatography. More particularly, the embodiments pertain to an improved imaging member having a dual charge generation layer comprising a top layer and a bottom layer, wherein the bottom layer comprises a blend of phthalocyanine pigments having different sensitivities and morphologies.

### BACKGROUND

The presently disclosed embodiments relate generally to layers that are useful in imaging apparatus members and components, for use in electrostatographic, including digital, apparatuses. More particularly, the embodiments pertain to an improved imaging member having a dual charge generation layer comprising a top layer and a bottom layer, wherein the bottom layer comprises a blend of phthalocyanine pigments having different sensitivities which do not have a direct impact on the apparent photosensitivity of the imaging member, where the sensitivity of the imaging member mainly derives from the top charge generation layer. This configuration provides an imaging member with improved performance, such as reduced ghosting.

Electrophotographic imaging members, e.g., photoreceptors, typically include a photoconductive layer formed on an electrically conductive substrate. The photoconductive layer is an insulator in the substantial absence of light so that electric charges are retained on its surface. Upon exposure to light, charge is generated by the photoactive pigment, and under applied field charge moves through the photoreceptor and the charge is dissipated.

In electrophotography, also known as xerography, electrophotographic imaging or electrostatographic imaging, the surface of an electrophotographic plate, drum, belt or the like (imaging member or photoreceptor) containing a photoconductive insulating layer on a conductive layer is first uniformly electrostatically charged. The imaging member is then exposed to a pattern of activating electromagnetic radiation, such as light. Charge generated by the photoactive pigment move under the force of the applied field. The movement of the charge through the photoreceptor selectively dissipates the charge on the illuminated areas of the photoconductive insulating layer while leaving behind an electrostatic latent image. This electrostatic latent image may then be developed to form a visible image by depositing oppositely charged particles on the surface of the photoconductive insulating layer. The resulting visible image may then be transferred from the imaging member directly or indirectly (such as by a transfer or other member) to a print substrate, such as transparency or paper. The imaging process may be repeated many times with reusable imaging members.

An electrophotographic imaging member may be provided in a number of forms. For example, the imaging member may be a homogeneous layer of a single material such as vitreous selenium or it may be a composite layer containing a photoconductor and another material. In addition, the imaging member may be layered. These layers can be in any order, and sometimes can be combined in a single or mixed layer.

Typical multilayered photoreceptors or imaging members have at least two layers, and may include a substrate, a conductive layer, an optional charge blocking layer, an optional adhesive layer, a photogenerating layer (sometimes referred to as a “charge generation layer,” “charge generating layer,” or “charge generator layer”), a charge transport layer, an optional overcoating layer and, in some belt embodiments, an anticurl backing layer. In the multilayer configuration, the active layers of the photoreceptor are the charge generation layer (CGL) and the charge transport layer (CTL). Enhancement of charge transport across these layers provides better photoreceptor performance.

The demand for improved print quality in xerographic reproduction is increasing, especially with the advent of color. Common print quality issues often arise in these conventional imaging members. For example, conventional materials used for photoreceptor layers have been problematic because print quality issues are strongly dependent on the quality of these layers. For example, charge deficient spots (“CDS”) and bias charge roll (“BCR”) leakage breakdown are problems that commonly occur. Another problem is “ghosting,” which is thought to result from the accumulation of charge somewhere in the photoreceptor. Consequently, when a sequential image is printed, the accumulated charge results in image density changes in the current printed image that reveals the previously printed image.

Thus, conventional formulations used to make these photoreceptor layers, while suitable for their intended purpose, do suffer from print quality issues such as ghosting. However; changing the existing formulations to address such issues may impact the way the photoreceptor layers interact and could adversely affect other electrical properties.

The term “photoreceptor” or “photoconductor” is generally used interchangeably with the terms “imaging member.” The term “electrostatographic” includes “electrophotographic” and “xerographic.” The terms “charge transport molecule” are generally used interchangeably with the terms “hole transport molecule.”

### SUMMARY

According to aspects illustrated herein, there is provided an imaging member comprising: a substrate having a first and second side, wherein the substrate has a conductive surface; an undercoat layer disposed on the first side of the substrate; and an imaging layer disposed on the undercoat layer, wherein the imaging layer comprises a dual charge generation layer disposed on the undercoat layer, wherein the dual charge generation layer has a top layer and a bottom layer and the top layer comprises hydroxygallium phthalocyanine Type V (HOGaPC(V)) pigment and the bottom layer comprises a blend of phthalocyanine pigments having different sensitivities (and morphologies), and a charge transport layer disposed on the dual charge generation layer, wherein the charge transport layer comprises a polycarbonate binder. The bottom layer is adjusted or tuned through a weight ratio of the different phthalocyanine pigments in the blend to obtain an optimal device performances such as print quality and operational life.

Another embodiment may provide an imaging member comprising: a substrate having a first and second side, wherein the substrate has a conductive surface; an undercoat layer disposed on the first side of the substrate; and an imaging layer disposed on the undercoat layer, wherein the imaging layer comprises a dual charge generation layer disposed on the undercoat layer, wherein the dual charge generation layer has a top layer and a bottom layer and the top layer comprises hydroxygallium phthalocyanine Type V pigment and the bottom layer comprises a blend of phthalocyanine pigments having different sensitivities and morphologies, and a weight ratio of two phthalocyanine pigments is from about 2/98 to about 98/2, or from about 25/75 to about 75/25, and a charge transport layer disposed on the dual charge generation layer, wherein the charge transport layer comprises a weight ratio of about 50/50 polycarbonate binder/charge transport molecule.

Yet another embodiment provides an image forming apparatus for forming images on a recording medium comprising: a) an imaging member having a charge retentive-surface to receive an electrostatic latent image thereon, wherein the imaging member comprises a substrate having a first and second side, wherein the substrate has a conductive surface, an undercoat layer disposed on the first side of the substrate, and an imaging layer disposed on the undercoat layer, wherein the imaging layer comprises a dual charge generation layer disposed on the undercoat layer, wherein the dual charge generation layer has a top layer and a bottom layer and the top layer comprises hydroxygallium phthalocyanine Type V pigment and the bottom layer comprises a blend of phthalocyanine pigments having different sensitivities and morphologies, and a charge transport layer disposed on the dual charge generation layer, wherein the charge transport layer comprises a polycarbonate binder; b) a development member for applying a developer material to the charge-retentive surface to develop the electrostatic latent image to form a developed image on the charge-retentive surface; c) a transfer member for transferring the developed image from the charge-retentive surface to an intermediate transfer member or a copy substrate; and d) a fusing member for fusing the developed image to the copy substrate.

### BRIEF DESCRIPTION OF THE DRAWINGS

For a better understanding, reference may be had to the accompanying figures.

FIG. 1 is a schematic nonstructural view showing an image forming apparatus according to the present embodiments;

FIG. 2 is a cross-sectional view of an imaging member showing various layers according to the present embodiments;

FIG. 3 is graph illustrating the relative ghost signal of imaging members of the present embodiments using different crude titanyl phthalocyanine (TiOPC(I))/high sensitivity titanyl phthalocyanine (TiOPC(IV)) ratios as compared to a control; and

FIG. 4 is graph illustrating the relative ghost signal of imaging members of the present embodiments using different TiOPC(I)/TiOPC(IV) ratios as compared to a control.

### DETAILED DESCRIPTION

In the following description, reference is made to the accompanying drawings, which form a part hereof and which illustrate several embodiments. It is understood that other embodiments may be utilized and structural and operational changes may be made without departure from the scope of the present disclosure. The same reference numerals are used to identify the same structure in different figures unless specified otherwise. The structures in the figures are not drawn according to their relative proportions and the drawings should not be interpreted as limiting the disclosure in size, relative size, or location.

The presently disclosed embodiments are directed generally to an improved imaging member having a specific configuration that provides improved performance. The configuration helps minimize or eliminate charge accumulation in imaging members, especially belt imaging members, without sacrificing the other electrical properties.

More particularly, the embodiments pertain to an improved imaging member having a dual charge generation layer comprising a top layer and a bottom layer, wherein the bottom layer comprises a blend of phthalocyanine pigments having different sensitivities and morphologies. This configuration provides an imaging member with improved performance, such as reduced ghosting.

Ghost print defects, in particular for those associated with belt imaging members, are one of the most difficult, challenging technical issues in xerography. Currently, there appears to be no viable solution without some compromises to product quality and/or manufacturability. By using a dual charge generation layer that is comprised of two photosensitive pigments coated underneath a regular photosensitive layer, ghosting or the tendency to ghosting can be adjusted by changing the ratio between the two photosensitive pigments. In embodiments, the two pigments selected are crude titanyl phthalocyanine (TiOPC Type I or TiOPC(I)) and high sensitivity titanyl phthalocyanine (TiOPC Type IV or TiOPC(IV)). In another embodiment, the two pigments selected are hydroxygallium phthalocyanine Type I (HOGaPC(I)) and hydroxygallium phthalocyanine Type V (HOGaPC(V)).

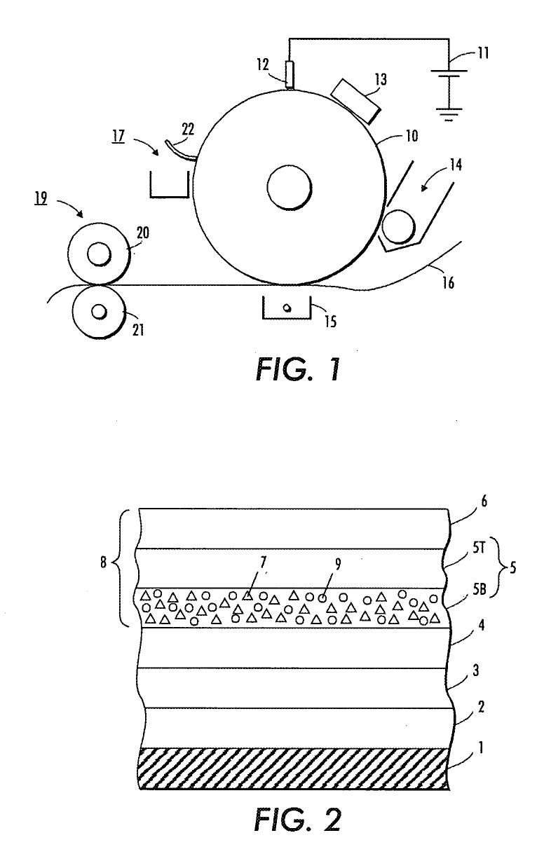

Referring to FIG. 1, in a typical electrostatographic reproducing apparatus, a light image of an original to be copied is recorded in the form of an electrostatic latent image upon a photosensitive member and the latent image is subsequently rendered visible by the application of electroscopic thermoplastic resin particles which are commonly referred to as toner. Specifically, photoreceptor 10 is charged on its surface by means of an electrical charger 12 to which a voltage has been supplied from power supply 11. The photoreceptor is then imagewise exposed to light from an optical system or an image input apparatus 13, such as a laser and light emitting diode, to form an electrostatic latent image thereon. Generally, the electrostatic latent image is developed by bringing a developer mixture from developer station 14 into contact therewith. Development can be effected by use of a magnetic brush, powder cloud, or other known development process.

After the toner particles have been deposited on the photoconductive surface, in image configuration, they are transferred to a copy sheet 16 by transfer means 15, which can be pressure transfer or electrostatic transfer. In embodiments, the developed image can be transferred to an intermediate transfer member and subsequently transferred to a copy sheet.

After the transfer of the developed image is completed, copy sheet 16 advances to fusing station 19, depicted in FIG. 1 as fusing and pressure rolls, wherein the developed image is fused to copy sheet 16 by passing copy sheet 16 between the fusing member 20 and pressure member 21, thereby forming a permanent image. Fusing may be accomplished by other fusing members such as a fusing belt in pressure contact with a pressure roller, fusing roller in contact with a pressure belt, or other like systems. Photoreceptor 10, subsequent to transfer, advances to cleaning station 17, wherein any toner left on photoreceptor 10 is cleaned therefrom by use of a blade 24 (as shown in FIG. 1), brush, or other cleaning apparatus.

Electrophotographic imaging members are well known in the art. Electrophotographic imaging members may be prepared by any suitable technique. Referring to FIG. 2, typically, a flexible or rigid substrate 1 is provided with an electrically conductive surface or coating 2. The substrate may be opaque or substantially transparent and may comprise any suitable material having the required mechanical properties. Accordingly, the substrate may comprise a layer of an electrically non-conductive or conductive material such as an inorganic or an organic composition. As electrically non-conducting materials, there may be employed various resins known for this purpose including polyesters, polycarbonates, polyamides, polyurethanes, and the like which are flexible as thin webs. An electrically conducting substrate may be any metal, for example, aluminum, nickel, steel, copper, and the like or a polymeric material, as described above, filled with an electrically conducting substance, such as carbon, metallic powder, and the like or an organic electrically conducting material. The electrically insulating or conductive substrate may be in the form of an endless flexible belt, a web, a rigid cylinder, a sheet and the like. The thickness of the substrate layer depends on numerous factors, including strength desired and economical considerations. Thus, for a drum, this layer may be of substantial thickness of, for example, up to many centimeters or of a minimum thickness of less than a millimeter. Similarly, a flexible belt may be of substantial thickness, for example, about 250 micrometers, or of minimum thickness less than 50 micrometers, provided there are no adverse effects on the final electrophotographic device.

In embodiments where the substrate layer is not conductive, the surface thereof may be rendered electrically conductive by an electrically conductive coating 2. The conductive coating may vary in thickness over substantially wide ranges depending upon the optical transparency, degree of flexibility desired, and economic factors. Accordingly, for a flexible photoresponsive imaging device, the thickness of the conductive coating may be between about 20 angstroms to about 750 angstroms, or from about 100 angstroms to about 200 angstroms for an optimum combination of electrical conductivity, flexibility and light transmission. The flexible conductive coating may be an electrically conductive metal layer formed, for example, on the substrate by any suitable coating technique, such as a vacuum depositing technique or electrodeposition. Typical metals include aluminum, zirconium, niobium, tantalum, vanadium and hafnium, titanium, nickel, stainless steel, chromium, tungsten, molybdenum, and the like.

An optional hole blocking layer or undercoat layer 3 may be applied to the substrate 1 or coating. Any suitable and conventional blocking layer capable of forming an electronic barrier to holes between the adjacent photoconductive layer 8 (or electrophotographic imaging layer 8) and the underlying conductive surface 2 of substrate 1 may be used.

An optional adhesive layer 4 may be applied to the hole-blocking layer 3. Any suitable adhesive layer well known in the art may be used. Typical adhesive layer materials include, for example, polyesters, polyurethanes, and the like. Satisfactory results may be achieved with adhesive layer thickness between about 0.05 micrometer (500 angstroms) and about 0.3 micrometer (3,000 angstroms). Conventional techniques for applying an adhesive layer coating mixture to the hole blocking layer include spraying, dip coating, roll coating, wire wound rod coating, gravure coating, Bird applicator coating, and the like. Drying of the deposited coating may be effected by any suitable conventional technique such as oven drying, infrared radiation drying, air drying and the like.

At least one electrophotographic imaging layer 8 is formed on the adhesive layer 4, blocking layer 3 or substrate 1. The electrophotographic imaging layer 8 has both a charge generation layer 5 and charge transport layer 6. In the present embodiments, the charge generation layer 5 is a dual charge generation layer 5 having a top layer 5T and a bottom layer 5B. These layers 5T and 5B may have thicknesses of from about 0.2 μm to about 0.3 μm in embodiments, but thicknesses outside of these ranges may also be used.

The dual charge generation layer 5 can be applied to the electrically conductive surface, or on other surfaces in between the substrate 1 and charge generating layer 5. A charge blocking layer or hole-blocking layer 3 may optionally be applied to the electrically conductive surface prior to the application of a charge generating layer 5. If desired, an adhesive layer 4 may be used between the charge blocking or hole-blocking layer 3 and the charge generation layer 5. Usually, the charge generation layer 5 is applied onto the blocking layer 3 and a charge transport layer 6, is formed on the charge generation layer 5. This structure may have the charge generation layer 5 on top of or below the charge transport layer 6.

Charge generator layers may comprise amorphous films of selenium and alloys of selenium and arsenic, tellurium, germanium and the like, hydrogenated amorphous silicon and compounds of silicon and germanium, carbon, oxygen, nitrogen and the like fabricated by vacuum evaporation or deposition. The charge-generator layers may also comprise inorganic pigments of crystalline selenium and its alloys; Group II-VI compounds; and organic pigments such as quinacridones, polycyclic pigments such as dibromo anthanthrone pigments, perylene and perinone diamines, polynuclear aromatic quinones, azo pigments including bis-, tris- and tetrakis-azos; and the like dispersed in a film forming polymeric binder and fabricated by solvent coating techniques.

Phthalocyanines have been employed as photogenerating materials for use in laser printers using infrared exposure systems. Infrared sensitivity is required for photoreceptors exposed to low-cost semiconductor laser diode light exposure devices. The absorption spectrum and photosensitivity of the phthalocyanines depend on the central metal atom of the compound. Many metal phthalocyanines have been reported and include, oxyvanadium phthalocyanine, chloroaluminum phthalocyanine, copper phthalocyanine, oxytitanium phthalocyanine, chlorogallium phthalocyanine, hydroxygallium phthalocyanine magnesium phthalocyanine and metal-free phthalocyanine. The phthalocyanines exist in many crystal forms, and have a strong influence on photogeneration.

In the present embodiments, the bottom layer 5B of the dual charge generation layer 5 comprises a blend of phthalocyanine pigments 7 and 9 having different sensitivities with a final pigment sensitivity being tuned through a weight ratio of the phthalocyanine pigments 7 and 9, while the top layer 5T comprises nominal HOGaPC(V). In one embodiment, the blend of phthalocyanine pigments comprises TiOPC(I) and TiOPC(IV). In another embodiment, the blend of phthalocyanine pigments comprises HOGaPC(I) and HOGaPC(V).

HOGaPC(I) is a precursor used in preparing HOGaPc(V) by solvent conversion, and has almost no photosensitivity. It has been noted that using HOGaPC(I) in the bottom layer 5B underneath a standard HOGaPc(V) generation layer results in a very strong negative SIR relative ghost signal. As HOGaPc(V) is known to have a high positive relative ghost signal of 8-12, it was contemplated that a low relative ghost signal could be achieved by determining an optimal combination of HOGaPc(V) and HOGaPc(I) that would yield such a low relative ghost signal.

TiOPC(I) is a precursor used in preparing TiOPC(IV), but has almost no photosensitivity itself. Similarly, it was noted that using TiOPC(I) in the bottom layer 5B underneath a standard HOGaPc(V) generation layer results in a very strong negative relative ghost signal. TiOPC(IV) is known to have a lower positive relative ghost signal than that of standard HOGaPc(V). However, it was still contemplated that a low relative ghost signal could be achieved by determining an optimal combination of TiOPC(I) and TiOPC(IV).

Any suitable polymeric film forming binder material may be employed as the matrix in the charge-generating (photogenerating) binder layer. Typical polymeric film forming materials include those described, for example, in U.S. Pat. No. 3,121,006, the entire disclosure of which is incorporated herein by reference. Thus, typical organic polymeric film forming binders include thermoplastic and thermosetting resins such as polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl acetate, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrenebutadiene copolymers, vinylidenechloride-vinylchloride copolymers, vinylacetate-vinylidenechloride copolymers, styrene-alkyd resins, polyvinylcarbazole, and the like. These polymers may be block, random or alternating copolymers.

The photogenerating composition or pigment is present in the resinous binder composition in various amounts. Generally, however, from about 5 percent by volume to about 90 percent by volume of the photogenerating pigment is dispersed in about 10 percent by volume to about 95 percent by volume of the resinous binder, or from about 20 percent by volume to about 30 percent by volume of the photogenerating pigment is dispersed in about 70 percent by volume to about 80 percent by volume of the resinous binder composition. In one embodiment, about 8 percent by volume of the photogenerating pigment is dispersed in about 92 percent by volume of the resinous binder composition. The photogenerator layers can also fabricated by vacuum sublimation in which case there is no binder.

In the present embodiments, poly(4,4′-cyclohexylidinediphenylene) carbonate (referred to as bisphenol-Z polycarbonate and/or PCZ-200) was used as binder for the bottom layer for both the dual generation layers using TiOPC(I) and TiOPC(IV) blend as well as the HOGaPC(I) and HOGaPC(V) blend. It appears that there was strong intermixing between the top and bottom layers. MAKROLON binder, a high molecular weight polycarbonate, was also used for the bottom layer so that the integrity of the layers would be better preserved.

Any suitable and conventional technique may be used to mix and thereafter apply the photogenerating layer coating mixture. Typical application techniques include spraying, dip coating, roll coating, wire wound rod coating, vacuum sublimation, and the like. For some applications, the generator layer may be fabricated in a dot or line pattern. Removing of the solvent of a solvent coated layer may be effected by any suitable conventional technique such as oven drying, infrared radiation drying, air drying and the like.

The charge transport layer 6 may comprise a charge transporting molecule dissolved or molecularly dispersed in a film forming electrically inert polymer such as a polycarbonate. The term “dissolved” as employed herein is defined herein as forming a solution in which the charge transporting molecule is dissolved in the polymer to form a homogeneous phase. The expression “molecularly dispersed” is used herein is defined as a charge transporting molecule dispersed in the polymer, the charge transporting molecules being dispersed in the polymer on a molecular scale. Any suitable charge transporting molecule or electrically active small molecule may be employed in the charge transport layer of this invention. The expression charge transporting “small” is defined herein as a monomer that allows the free charge photogenerated in the transport layer to be transported across the transport layer. Typical charge transporting small molecules include, for example, pyrazolines such as 1-phenyl-3-(4′-diethylamino styryl)-5-(4″-diethylamino phenyl)pyrazoline, diamines such as N,N′-diphenyl-N,N′-bis(3-methylphenyl)-(1,1′-biphenyl)-4,4′-diamine, hydrazones such as N-phenyl-N-methyl-3-(9-ethyl)carbazyl hydrazone and 4-diethyl amino benzaldehyde-1,2-diphenyl hydrazone, and oxadiazoles such as 2,5-bis(4-N,N′-diethylaminophenyl)-1,2,4-oxadiazole, stilbenes and the like. However, to avoid cycle-up in machines with high throughput, the charge transport layer should be substantially free (less than about two percent) of di or triamino-triphenyl methane. As indicated above, suitable electrically active small molecule charge transporting compounds are dissolved or molecularly dispersed in electrically inactive polymeric film forming materials. A small molecule charge transporting compound that permits injection of holes from the pigment into the charge generating layer with high efficiency and transports them across the charge transport layer with very short transit times is N,N′-diphenyl-N,N′-bis(3-methylphenyl)-(1,1′-biphenyl)-4,4′-diamine (TPD).

If desired, the charge transport material in the charge transport layer may comprise a polymeric charge transport material or a combination of a small molecule charge transport material and a polymeric charge transport material.

Any suitable electrically inactive resin binder insoluble in the alcohol solvent may be employed in the charge transport layer of this invention. Typical inactive resin binders include polycarbonate resin (such as MAKROLON), polyester, polyarylate, polyacrylate, polyether, polysulfone, and the like. Molecular weights can vary, for example, from about 20,000 to about 150,000. Examples of binders include polycarbonates such as poly(4,4′-isopropylidene-diphenylene)carbonate (also referred to as bisphenol-A-polycarbonate, poly(4,4′-cyclohexylidinediphenylene) carbonate (referred to as bisphenol-Z polycarbonate), poly(4,4′-isopropylidene-3,3′-dimethyl-diphenyl)carbonate (also referred to as bisphenol-C-polycarbonate) and the like. Any suitable charge transporting polymer may also be used in the charge transporting layer of this invention. The charge transporting polymer should be insoluble in the alcohol solvent employed to apply the overcoat layer of this invention. These electrically active charge transporting polymeric materials should be capable of supporting the injection of photogenerated holes from the charge generation material and be capable of allowing the transport of these holes there through.

Any suitable and conventional technique may be used to mix and thereafter apply the charge transport layer coating mixture to the charge generating layer. Typical application techniques include spraying, dip coating, roll coating, wire wound rod coating, and the like. Drying of the deposited coating may be effected by any suitable conventional technique such as oven drying, infrared radiation drying, air drying and the like.

Generally, the thickness of the charge transport layer is between about 10 and about 50 micrometers, or from about 10 μm to about 40 μm, but thicknesses outside this range can also be used. For example, in one embodiment, the thickness is about 27 μm. The hole transport layer should be an insulator to the extent that the electrostatic charge placed on the hole transport layer is not conducted in the absence of illumination at a rate sufficient to prevent formation and retention of an electrostatic latent image thereon. In general, the ratio of the thickness of the hole transport layer to the charge generator layers can be maintained from about 2:1 to 200:1 and in some instances as great as 400:1. The charge transport layer, is substantially non-absorbing to visible light or radiation in the region of intended use but is electrically “active” in that it allows the injection of photogenerated holes from the photoconductive layer, e.g., charge generation layer, and allows these holes to be transported through itself to selectively discharge a surface charge on the surface of the active layer.

In embodiments, an overcoat layer may be coated on the charge-transporting layer.

Any suitable or conventional technique may be used to mix and thereafter apply the overcoat layer coating mixture on the charge transport layer. Typical application techniques include spraying, dip coating, roll coating, wire wound rod coating, and the like. Drying of the deposited coating may be effected by any suitable conventional technique such as oven drying, infrared radiation drying, air drying, and the like. The dried overcoating should transport holes during imaging and should not have too high a free carrier concentration. Free carrier concentration in the overcoat increases the dark decay. In embodiments, the dark decay of the overcoated layer should be about the same as that of the uncoated, control device.

Various exemplary embodiments encompassed herein include a method of imaging which includes generating an electrostatic latent image on an imaging member, developing a latent image, and transferring the developed electrostatic image to a suitable substrate.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The example set forth herein below and is illustrative of different compositions and conditions that can be used in practicing the present embodiments. All proportions are by weight unless otherwise indicated. It will be apparent, however, that the embodiments can be practiced with many types of compositions and can have many different uses in accordance with the disclosure above and as pointed out hereinafter.

### Example 1

Imaging members were fabricated by using a substrate of pre-coated IFL/BLS on Ti/Zr metallized polyethylene napthalate (PEN). The ghost tunable element was first coated by selecting from a series of dispersions consisting of a mixture of TiOPC(I)/TiOPC(IV) at weight-to-weight ratios of 25/75, 50/50, 75/25, and 100/0. Then a standard HOGaPC(V)/PCZ200 charge generation layer or background generator layer (CGL) was coated. Finally, a 27 μm charge transport layer at 50/50 polycarbonate to charge transport molecule (N,N′-diphenyl-N,N′-bis(3-methylphenyl)-(1,1′-biphenyl)-4,4′-diamine (TPD)) ratio (MAKROLON to TPD) was coated on top of the standard HOGaPC(V) CGL.

Ghosting Measurement

When a photoconductor is selectively exposed to positive charges in a xerographic print engine, such as the Xerox Corporation iGen3®, it is observed that some of these charges enter the photoconductor and manifest themselves as a latent image in the next printing cycle. This print defect can cause a change in the lightness of the half tones and is commonly referred to as a “ghost” that is generated in the previous printing cycle.

An example of a source of the positive charges is the stream of positive ions emitted from the transfer corotron. Since the paper sheets are situated between the transfer corotron and the photoconductor, the photoconductor is shielded from the positive ions from the paper sheets. In the areas between the paper sheets the photoconductor is fully exposed, thus in this paper free zone the positives charges may enter the photoconductor. As a result these charges cause a print defect or ghost in a half tone print if one switches to a larger paper format that covers the previous paper free zone.

In the ghosting test the photoconductors were electrically cycled to simulate continuous printing. At the end of every tenth cycle known, incremental positive charges were injected. In the follow-on cycles the electrical response to these injected charges were measured and then translated into a rating scale.

The electrical response to the injected charges in the print engine and in the electrical test fixture was a drop in the surface potential. This drop was calibrated to calorimetric values in the prints and they in turn were calibrated to the ranking scale of an average rating of at least two observers. On this scale 1 refers to no observable ghost and values of 7 refer to a very strong ghost. The functional dependence between the change in surface potential and the ghosting scale is slightly supra-linear and may in first approximation be linearly scaled. Note that these tests are done under severe stress conditions, e.g., actuators in the print engine and in the test fixture are set as such to bring out the worst ghost.

Using a sputterer ⅜ inch diameter, 150 Å thick, gold dots were deposited onto the transport layer of the photoconductors of in the examples. Then they were dark rested (e.g., in the absence of light) for at least two days at 22° C. and 50% RH to allow relaxation of the surfaces.

These electroded photoconductor devices (gold dot on charge transport layer surface) were then cycled in a test fixture that injected positive charge through the gold dots with the methodology described above. The change in surface potential was then determined for injected charges of 27 nC/cm². This value was selected to be larger than typically expected in the Xerox Corporation iGen3® print engine to generate strong signals. Finally the changes in the surface potentials were translated into ghost rankings by the aforementioned calibration curves. This method was repeated 4 times for each photoconductor and then the averages were calculated. Typical standard deviation of the mean tested on numerous devices was about 0.35.

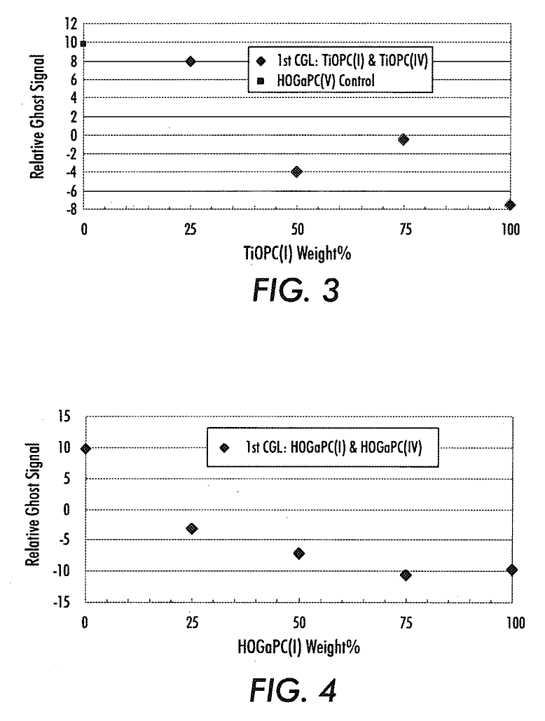

Results of ghost testing for Example 1 are shown in FIG. 3, where the first (bottom layer) CGL contains a mixture of TiOPC(I) and TiOPC(IV) in MAKROLON at TiOPC(I) weight % of 25, 50, 75, and 100. The second (top layer) CGL is always pure HOGaPC(V)/PCZ200. The control consisted of a first (bottom layer) CGL of pure HOGaPC(V)/MAKROLON and second (top layer) CGL pure HOGaPC(V)/PCZ200. The relative ghost signal of the control was 9.8, which falls within the typical relative ghost signal value, of 8-12 for HOGaPC(V) devices. By increasing the percentage of TiOPV(I) in the first (bottom layer) CGL, ghosting signal changed from positive to negative with the best value of −0.5 at TiOPC(I)/TiOPC(IV)=75/25, weight to weight ratio. The resulting relative ghost signals are about +8, −4, and −8 at TiOPC(I)/TiOPC(IV)=25/75, 50/50, and 100/0, respectively. The composition of the imaging members, from top to bottom configuration, was a 27 μm SMTL at 50/50 polycarbonate to charge transport molecule ratio (MAKROLON/TPD), a 0.2-0.3 μm HOGaPC(V)/PCZ200 CGL, a 0.2-0.3 μm tunable ghost element comprised of a mixture of TiOPC(I) and TiOPC(IV), and a pre-coated interfacial layer comprised of polyacrylate and a blocking layer comprised of silane interference layer (IFL/BLS) on Ti/Zr metallized polyethylene napthalate substrate.

Electrical scanning results demonstrated that the tunable elements have photoinduced discharge characteristics (PIDC) similar to that of the HOGaPC(V) control device. However, with pure TiOPC(I) as the first (bottom layer) CGL, the imaging member exhibits higher V_{low} and Vₜₐᵢₗ.

### Example 2

Imaging members were fabricated by using a substrate of pre-coated IFL/BLS on Ti/Zr metallized polyethylene napthalate (PEN). The ghost tunable element was first coated by selecting from a series of dispersions consisted of a mixture of and at weight-to-weight ratios of 0/100, 25/75, 50/50, 75/25, and 100/0, where the first mixture also acted as the control. Next, a standard HOGaPC(V)/PCZ200 charge generation layer (CGL) was coated. Finally, a 27 μm SMTL at 50/50 polycarbonate to charge transport molecule ratio (MAKROLON/TPD) was coated on top of the standard Pc7 CGL.

Results of relative ghost signal for Example 2 are shown in FIG. 4, where the first (bottom layer) CGL contains a mixture of HOGaPC(I) and HOGaPC(V) in MAKROLON at HOGaPC(I) weight % of 0, 25, 50, 75, and 100. The second (top layer) CGL is always pure HOGaPC(V)/PCZ200. The control consisted of a first (bottom layer) CGL of pure HOGaPC(V)/MAKROLON(HOGaPC(I) weight %=0) and second (top layer) CGL pure HOGaPC(V)/PCZ200. The control had a relative ghost signal of 9.8, which falls within the typical relative ghost value of 8-12 for HOGaPC(V) devices. By increasing the percentage of HOGaPC(I) in the tunable ghost element, relative ghost signal changed from positive to negative with the best relative ghost signal of −2.8 at HOGaPC(I)/HOGaPC(V)=25/75. The relative ghost signals are about −7, −11, and −10 at HOGaPC(I)/HOGaPC(V)=50/50, 75/25, and 100/0, respectively. The composition of the imaging members, from top to bottom configuration, was a 27 μm SMTL at 50/50 polycarbonate to charge transport molecule ratio (MAKROLON/TPD), a 0.2-0.3 μm HOGaPC(V)/PCZ200 CGL, a 0.2-0.3 μm tunable ghost element comprised of a mixture of HOGaPC(I) and HOGaPC(V) in MAKROLON, and a pre-coated IFL/BLS on Ti/Zr metallized polyethylene napthalate substrate.

Electrical scanning demonstrated that, at HOGaPC(I) weight percentages of 25 and 50, the tunable elements have similar photoinduced discharge characteristics to that of the HOGaPC(V) control device. However, at higher HOGaPC(I) ratios, the devices exhibit high V_{low} and Vₜₐᵢₗ.

In summary, using a tunable ghost element as an intermediate layer inserted between the undercoat layers and regular charge generation layer has been implemented with HOGaPC(I) and HOGaPC(V) as well as TiOPC(I) and TiOPC(IV) as the tunable agents, and imaging members employing such configurations have demonstrated substantially reduced ghosting.

All the patents and applications referred to herein are hereby specifically, and totally incorporated herein by reference in their entirety in the instant specification.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. An imaging member comprising:
a substrate having a first and second side, wherein the substrate has a conductive surface;
an undercoat layer disposed on the first side of the substrate; and
an imaging layer disposed on the undercoat layer, wherein the imaging layer comprises
a dual charge generation layer disposed on the undercoat layer, wherein the dual charge generation layer has a top layer and a bottom layer and the top layer comprises hydroxygallium phthalocyanine Type V pigment and the bottom layer comprises a blend of phthalocyanine pigments having different sensitivities and morphologies, and
a charge transport layer disposed on the dual charge generation layer, wherein the charge transport layer comprises a polycarbonate binder.

2. The imaging member of claim 1, wherein the top and bottom layers have a thickness of from about 0.2 μm to about 0.3 μm.

3. The imaging member of claim 1, wherein the blend of phthalocyanine pigments comprises hydroxygallium phthalocyanine Type I and hydroxygallium phthalocyanine Type V.

4. The imaging member of claim 3, wherein a weight ratio of the phthalocyanine pigments is from about 2/98 to about 98/2 hydroxygallium phthalocyanine Type I/hydroxygallium phthalocyanine Type V.

5. The imaging member of claim 4, wherein a weight ratio of the phthalocyanine pigments is from about 25/75 to about 50/50 hydroxygallium phthalocyanine Type I/hydroxygallium phthalocyanine Type V.

6. The imaging member of claim 1, wherein the blend of phthalocyanine pigments comprises titanyl phthalocyanine Type I and titanyl phthalocyanine Type IV.

7. The imaging member of claim 6, wherein a weight ratio of the phthalocyanine pigments is from about 2/98 to about 98/2 titanyl phthalocyanine Type I/titanyl phthalocyanine Type IV.

8. The imaging member of claim 7, wherein a weight ratio of the phthalocyanine pigments is from about 50/50 to about 75/25 titanyl phthalocyanine Type I/titanyl phthalocyanine Type IV.

9. The imaging member of claim 1, wherein the top layer of the dual charge generation layer comprises poly(4,4′-dihydroxy-diphenyl-1-1-cyclohexane).

10. The imaging member of claim 1, wherein the charge transport layer has a thickness of from about 10 μm to about 40 μm.

11. The imaging member of claim 1, wherein the charge transport layer has a charge transport molecule comprising N,N′-diphenyl-N,N′-bis[3-methylpropyl]-[1,1′-biphenyl]-4,4′-diamine.

12. The imaging member of claim 1, wherein the substrate comprises metallized polyethylene napthalate.

13. The imaging member of claim 1 having a lower ghost signal than that of an imaging member having a bottom layer consisting of HOGaPC(V).

14. An imaging member comprising:
a substrate having a first and second side, wherein the substrate has a conductive surface;
an undercoat layer disposed on the first side of the substrate; and
an imaging layer disposed on the undercoat layer, wherein the imaging layer comprises
a dual charge generation layer disposed on the undercoat layer, wherein the dual charge generation layer has a top layer and a bottom layer and the top layer comprises hydroxygallium phthalocyanine Type V pigment and the bottom layer comprises a blend of phthalocyanine pigments having different sensitivities and morphologies, and a weight ratio of two phthalocyanine pigments is from about 25/75 to about 75/25, and
a charge transport layer disposed on the dual charge generation layer, wherein the charge transport layer comprises a weight ratio of about 50/50 polycarbonate binder/charge transport molecule.

15. An image forming apparatus for forming images on a recording medium comprising:
a) an imaging member having a charge retentive-surface to receive an electrostatic latent image thereon, wherein the imaging member comprises a substrate having a first and second side, wherein the substrate has a conductive surface, an undercoat layer disposed on the first side of the substrate, and an imaging layer disposed on the undercoat layer, wherein the imaging layer comprises a dual charge generation layer disposed on the undercoat layer, wherein the dual charge generation layer has a top layer and a bottom layer and the top layer comprises hydroxygallium phthalocyanine Type V pigment and the bottom layer comprises a blend of phthalocyanine pigments having different sensitivities and morphologies, and a charge transport layer disposed on the dual charge generation layer, wherein the charge transport layer comprises a polycarbonate binder.
b) a development member for applying a developer material to the charge-retentive surface to develop the electrostatic latent image to form a developed image on the charge-retentive surface;
c) a transfer member for transferring the developed image from the charge-retentive surface to an intermediate transfer member or a copy substrate; and
d) a fusing member for fusing the developed image to the copy substrate.

16. The image forming apparatus of claim 15, wherein the blend of phthalocyanine pigments comprises hydroxygallium phthalocyanine Type I and hydroxygallium phthalocyanine Type V.

17. The image forming apparatus of claim 16, wherein a weight ratio of the phthalocyanine pigments is from about 2/98 to about 98/2 hydroxygallium phthalocyanine Type I/hydroxygallium phthalocyanine Type V.

18. The image forming apparatus of claim 15, wherein the blend of phthalocyanine pigments comprises titanyl phthalocyanine Type I and titanyl phthalocyanine Type IV.

19. The image forming apparatus of claim 18, wherein a weight ratio of the phthalocyanine pigments is from about 2/98 to about 98/2 titanyl phthalocyanine Type I/titanyl phthalocyanine Type IV.

20. The imaging forming apparatus of claim 15, wherein the top and bottom layers have a thickness of from about 0.2 μm to about 0.3 μm.

21. The image forming apparatus of claim 15, wherein the charge transport layer has a weight ratio of 50/50 polycarbonate binder/charge transport molecule.

22. The image forming apparatus of claim 15, wherein the substrate comprises metallized polyethylene napthalate.
